(19) United States
(12) Patent Application Publication
(10) Pub. No.: US 2012/0210725 A1
(43) Pub. Date: Aug. 23, 2012

(54) NON-FLAME-OUT TEST FOR THE COMBUSTION CHAMBER OF A TURBINE ENGINE

(75) Inventors: Philippe Roger Courtie, Rontignon (FR); Philippe Etchepare, Pau (FR); Hubert Pascal Verdier, Nay (FR)

(73) Assignee: TURBOMECA, Bordes (FR)

(21) Appl. No.: 13/499,936

(22) PCT Filed: Oct. 18, 2010
(86) PCT No.: PCT/EP2010/065664

§ 371 Date: Apr. 3, 2012

(30) Foreign Application Priority Data
Oct. 19, 2009 (FR) 0957303

(51) Int. Cl. F02C 9/28; G06F 19/00; G01M 15/14

(52) U.S. Cl. 60/773; 60/39.281; 702/115

(57) ABSTRACT

A method for ground control of proper operation of an aeronautical turbine engine for a plane. A test includes carrying out, on the operating turbine engine and from a predetermined speed, a quick reduction in fuel flow according to a programmed decrease to evaluate flame-out resistance of the combustion chamber of the turbine engine during a quick inflight deceleration maneuver of the speed thereof.

The field of the present invention is that of thermodynamics applied to turbine engines and more particularly that of the operation of aeronautical turbine engines.

Turbine engines are conventionally constituted by one or more compressors which compress the air drawn into an air intake, a combustion chamber where fuel mixed with the air is burnt, one or more turbines which take a part of the power generated by the combustion in order to drive the compressor or compressors and an output nozzle through which the gasses produced are ejected.

Aeronautical turbine engines are used in wide flight conditions, in which their operation must be guaranteed in order to ensure the safety of the crew and that of possible passengers. In particular, it is essential to prevent the turbojet of an aircraft or the turbine engine of a helicopter from cutting out during a maneuver operated by the pilot. There is a risk of such a flame-out in the combustion chamber occurring when, for example, the pilot carries out a maneuver of rapid reduction in the thrust or in the power delivered. This type of maneuver can be carried out urgently when the pilot in an aircraft wishes to suddenly slow down its speed or, in a helicopter, tries to decelerate rapidly in order, for example, to avoid an obstacle which appears suddenly in front of him (a maneuver called “quick stop” or rapid deceleration).

In normal operation the regulation of the engine is provided for controlling the flow of fuel which is injected into the combustion chamber and to avoid such a flame-out. However, in the case of a failure of this regulation or of changes in the physical characteristics of the engine parts, such a flame-out is not excluded. Such a fault can occur as the engine ages, which generates changes in the clearances or in the size of the air intake orifices or in the fuel injection and regulation system. This subsequently results in a quantity of air taken into the chamber which is greater than that expected or in a quantity of fuel injected into the chamber which is less that that expected and consequently in a sudden reduction in the richness of the mixture.

During a rapid deceleration maneuver, the sudden reduction in the fuel flow which is injected into the combustion chamber results in an instantaneous modification of the richness of the mixture. In fact, the reduction in the fuel flow is virtually immediate when the fuel flow control valve is closed whilst the reduction in the air flow follows the decrease in the speed of rotation of the engine shaft, the rate of change of which is limited by the inertia of the rotor and which is not therefore instantaneous. The richness varies suddenly from its nominal value to a lean value, which is only likely to become nominal again when the engine rotation speed becomes stabilized at its new value. The stability of a flame in a combustion chamber is guaranteed only if the richness of the mixture remains between two extreme values, a value called the rich flame-out value and a value called the lean flame-out value.

In the case of an emergency maneuver of the quick stop type, if the engine is failing for one of the above-mentioned causes, it is then possible for the richness to drop below the lean flame-out value and for the engine to cut out. In order to check the ability of an engine to resist this flame-out phenomenon during these emergency maneuvers, only a test on a test bench at present makes it possible to carry out the corresponding diagnostics. It is moreover only carried out when accepting new engines. The engines are no longer checked thereafter, except during a complete overhaul. If the characteristics of the engine change, the risk of a failure therefore remains completely unnoticed in normal operation because, as the normal speed reductions are not as severe as that brought about by an emergency maneuver as described above, the richness of the mixture does not drop low enough to reach the lean flame-out limit. It is therefore possible for the engine to cut out if the pilot has to carry out this emergency maneuver, that is to say at a time when he particularly needs it.

The purpose of the present invention is to overcome these disadvantages by proposing a method, that can be carried out when an aircraft is on the ground, for testing the correct operation of the engine for the case in which it would be necessary to carry out a rapid deceleration maneuver in flight. This method furthermore makes it possible to assess if the combustion chamber has suffered possible degradation.

For this purpose, the invention relates to a method for testing the correct operation of an aeronautical turbine engine on the ground, characterized in that it comprises the carrying out, on the turbine engine whilst it is operating and starting from a predetermined rotation speed, a rapid reduction in the fuel flow according to a programmed decrease, for the purpose of evaluating the resistance to flame-out of the combustion chamber of said turbine engine during a rapid in-flight deceleration of its speed maneuver.

The test consists in observing a possible flame-out of the combustion chamber during this maneuver and in deducing if the engine is capable of withstanding a rapid deceleration maneuver in flight.

The decrease is preferably carried out automatically by the engine's computer, when the pilot or a mechanic operates a dedicated control associated with said computer.

It is thus ensured that the decrease carried out perfectly follows the nominal decrease of the test. The complexity of the carrying out of the test by pilots and/or mechanics is also limited.

Advantageously, the engine rotation speed at the start of the test is varied as a function of the temperature and pressure conditions of the place of execution of said correct operation check.

Even more advantageously, the rate of decrease in the fuel flow during the test is varied as a function of the temperature and pressure conditions of the place of execution of said correct operation check.

This makes it possible to take account of the particular characteristics of the place where the test takes place and therefore to carry it out in conditions representative of the operation of the combustion chamber.

The invention also relates to a method of determining the limit value of the decrease in the fuel flow after which flame-out of the combustion chamber of an aeronautical turbine engine occurs by successively carrying out several tests such as described above, the applied decrease rates being greater each time with respect to the preceding test.

Preferably, the fuel flow injected into the combustion chamber is adjusted as a function of the flame-out limit found according to the above method.

Finally, the invention relates to a computer for regulating the fuel flow injected into an aeronautical turbine engine, wherein there is installed a module for carrying out one of the methods described above and to an aeronautical turbine engine comprising such a computer.

The invention will be better understood and other objectives, details, features and advantages of the latter will appear more clearly during the following detailed explicative description of an embodiment of the invention given as a purely illustrative and non-limiting example, with reference to the appended diagrammatic drawing.

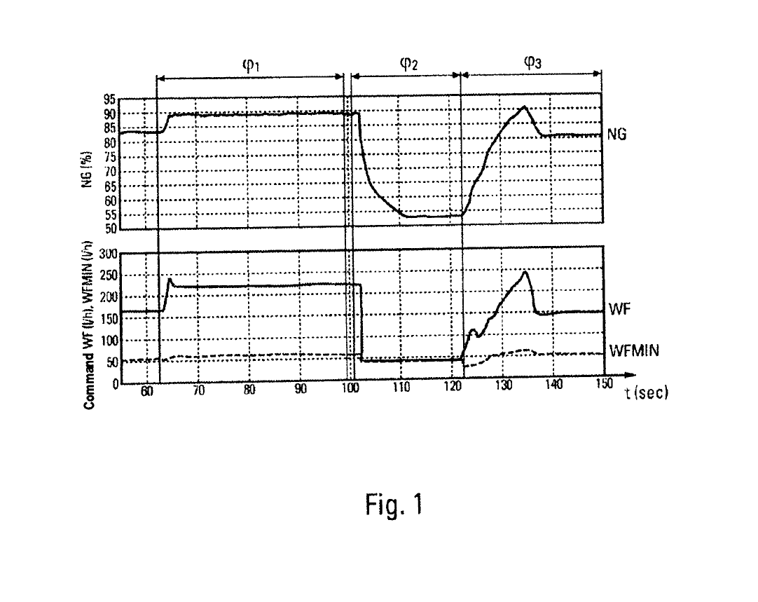

The speed of the gas generator (NG), the flow (WF) commanded by the computer and the minimum flow limit (WFMIN) imposed by the computer during a non-flame-out test are shown in FIG. 1.

The flow command is the value of the flow requested by the computer from the regulation system which acts on the position of the fuel metering valve. The minimum flow value is a limit value, defined in the computer, which fixes a low limit to the flow command transmitted by the computer. The flame-out or non-flame-out of the combustion chamber in the case of a rapid rotation speed reduction is related to the correct setting of this minimum value.

The variation of the parameters in FIG. 1 is broken down into three phases, referenced φ1, φ2 and φ3. Phase 1 corresponds to a phase of preparation of the test, during which the pilot sets a rotation speed specified in advance (typically 90% of the full-throttle value) and waits for this speed to become stabilized. This stabilization is monitored by the computer which authorizes the start of phase 2 only if it is effective. Phase 2 corresponds to the initiation of the test by the computer, in response to a request from the pilot or from the mechanic and phase 3 corresponds to the return to normal operation, idling, after the test. The initiation of phase 2 is accompanied by a calibrated reduction in the minimum flow command value WFMIN below its value as defined by the computer in normal use.

During phase 1, with the rotation speed stable at 90%, the flow command transmitted by the computer is constant once the speed is stabilized, and equal to the flow necessary for maintaining this speed value, the value of the minimum flow command, which corresponds to the maximum decrease that the computer would authorize in the case of sudden reduction in the speed of the engine, is itself also stable and equal to its normal operating value.

When the computer initiates the test, this results in a sudden reduction in the flow command and the sending of the latter at the minimum flow command value which is programmed in the computer for the test and which is, as mentioned above, voluntarily set at a value lower than that which it has in normal operation. This reduced value of the minimum flow command is precisely that which it is sought to test, that is to say that for which it is desired to check the absence of flame-out of the engine during an emergency maneuver. The speed of the engine decreases rapidly, in keeping with the inertia of its rotating parts, and becomes stabilized, in the case shown in FIG. 1 where there is actually no flame-out, at a given value, lower than that of idling.

Phase 3 corresponds to the return to normal conditions, with the stopping of the test which is materialized by an increase in the flow command, to its value corresponding to idling. The increase in the flow command results in an increase in the engine speed towards idling where it again becomes stabilized. The value of the minimum flow command itself remains constant, apart from transient oscillations.

In order to solve the problem raised, the invention proposes the installation, in the engine's computer which controls the fuel flow injected into the combustion chamber at all times, a module whose activation initiates a specific non-flame-out test procedure, to be carried out on the ground, with the engine running, for example during engine run-up, that is to say during the test for correct operation of the engine carried out for each flight before takeoff.

This test consists in carrying out a programmed reduction in the quantity of fuel injected, in such a way as to simulate the decrease in the flow during an emergency maneuver, such as a quick stop, and in reproducing richness conditions close to those which would exist during this maneuver. The reduction in the quantity of fuel injected is carried out by suddenly changing the flow command WF transmitted by the computer to the regulation system which controls the setting of the fuel metering valve and by instantaneously giving this command WF a predefined minimum command value WFMIN. This decrease takes place down to a value of WFMIN which is lower than the minimum flow command used in normal operation, in order to simulate the minimum richness which would occur in the combustion chamber of the engine during a maneuver of the quick stop type. This minimum flow command value used for the test is defined by the engineering department during the design of the engine, on the basis of calculations of the operation of the chamber or on the basis of in-flight recordings taken on an aircraft under test. It is varied according to the conditions in which this test is carried out, such as for example the altitude of the airfield where the aircraft is located, the atmospheric conditions, etc. This variation of the value given to the minimum flow command WFMIN to be set during the test is related, among other things, to the value of the engine rotation speed fixed at the start of the non-flame-out test.

The procedure takes place as follows: according to a frequency prescribed in the flight manual or the maintenance manual, the pilot initiates the simulated rapid deceleration maneuver by operating a specific control associated with the engine's computer. The latter then initiates the programmed decrease by sending a flow command WF equal to the value of the minimum flow command WFMIN predefined for the test, which results in the movement, in the direction of closing, of the fuel flow control valve, and the pilot checks if there is or is not flame-out of the combustion chamber. If there is no flame-out, the engine is considered as being in nominal flight conditions and the following flight can take place. The pilot thus knows that the engine is sound with respect to the risk of rapid deceleration and that he can carry out such an emergency maneuver without risk if it is felt to be necessary in flight.

If there is flame-out during the test on the ground, this signifies that the engine is not in its normal operating conditions and that it is appropriate to provide a maintenance operation before issuing its return to flight authorization. Such a maintenance operation, which will be specified in the engine's operating manual, can for example comprise removing the engine and sending it to the workshop. The cause of the incorrect operation will be sought at the level of poor operation of the fuel injection regulation system and at the level of degradation of the performance of the chamber, for example because of its aging.

Complementary analyses can also be proposed in the context of this non-flame-out test: searching for the flame-out limit by several tests and then, depending on the value found for the minimum fuel flow command WFMIN guaranteeing non-flame-out, adapting the operating rules in the computer to take account of the observed performance losses can be envisaged. The maximum decrease in the fuel flow fixed by the computer for normal use is therefore limited in order to guarantee non-flame-out; consequently the engine can continue to be used without risk and without it being necessary to remove it and to install a sound engine on the aircraft.

1-8. (canceled)

9. A method for testing, on the ground, a flame out avoidance function of a system for regulating fuel flow injected into a combustion chamber of an aeronautical turbine engine, the system being controlled by a computer transmitting to it a command of a value of the fuel flow to be injected, the value being higher than a limit value predefined by the computer to avoid risk of flame-out in a case of a rapid reduction in a flow command maneuver, the method comprising:
carrying out, on the turbine machine whilst it is operating and starting from a predetermined rotation speed, a reduction in the flow of fuel according to a decrease programmed to reach a flow command value lower than the limit value corresponding to the operation on the ground in question;
followed by verification of non-flame-out of the combustion chamber.

10. The method as claimed in claim 9, wherein the decrease is carried out automatically by the engine's computer, when a pilot or a mechanic operates a dedicated control associated with the computer.

11. The method as claimed in claim 9, wherein engine rotation speed at a start of the test is varied as a function of temperature and pressure conditions of a place of execution of the operation test.

12. The method as claimed in claim 9, wherein the reduction in the fuel flow during the test is varied as a function of temperature and pressure conditions of a place of execution of the operation test.

13. A method of determining the limit value of the decrease in the fuel flow after which flame-out of the combustion chamber of an aeronautical turbine engine occurs by successively carrying out plural tests as claimed in one of claims 9 to 12, the decreases being greater each time with respect to a preceding test.

14. A method of regulating the fuel flow injected into the combustion chamber of an aeronautical turbine engine, wherein the fuel flow is adjusted as a function of the flame-out limit found according to the method as claimed in claim 13.

15. A computer for regulating the fuel flow injected into an aeronautical turbine engine, wherein there is installed a module for carrying out a method as claimed in one of claims 9 to 12.

16. An aeronautical turbine engine comprising a computer as claimed in claim 15.
